(19) United States
(12) Patent Application Publication
(10) Pub. No.: US 2012/0081771 A1
(43) Pub. Date: Apr. 5, 2012

(54) OPTICAL SCANNING APPARATUS AND LASER POINTER

(75) Inventors: Toyoki TANAKA, Tokyo (JP); Takahiko Nishiyama, Tokyo (JP)

(73) Assignee: MITSUMI ELECTRONICS CO., LTD., Tokyo (JP)

(21) Appl. No.: 13/239,462

(22) Filed: Sep. 22, 2011

(30) Foreign Application Priority Data
Oct. 4, 2010 (JP) 2010-225192

(51) Int. Cl. G02B 26/10; G02B 27/20

(52) U.S. Cl. 359/205.1

(57) ABSTRACT

An optical scanning apparatus includes: a light source; a lens through which a light emitted from the light source transmits; a reflective member reflecting the light transmitting the lens; and a mirror configured to scan the light reflected by the reflective member. The light is projected in the same direction as an emitting direction of the light from said light source by causing said mirror to swing. The reflective member has a first reflective surface facing toward the light source and a second reflective surface facing toward a light exit surface from which the light exits from the optical scanning apparatus. The light source and the lens are arranged in a longitudinal direction of a case of the optical scanning apparatus. The mirror and the reflective member are arranged in a transverse direction of the case.

### BACKGROUND OF THE INVENTION

1. Field of the Invention

The present invention relates to an optical scanning apparatus having a mirror which swings to slightly change a direction of light exiting from the apparatus, and a laser pointer having such an optical scanning apparatus.

2. Description of the Related Art

Conventionally, there is an optical scanning apparatus that includes an optical micro-electro mechanical system (MEMS) having a mirror to reflect a laser light emitted by an optical source. The optical MEMS reflects the laser light to project an image. Generally, in such a conventional optical scanning apparatus, the mirror provided in the optical MEMS is arranged to oppose a light exiting surface of the apparatus.

FIG. 1A is an illustration of an outline structure of an example of a conventional optical scanning apparatus. In the optical scanning apparatus illustrated in FIG. 1A, a laser diode (LD) 12, a lens 13, an optical MEMS 14 and a polarization prism 15 are accommodated in a housing 11. In the optical scanning apparatus 10, the mirror of the optical MEMS 14 is arranged at a position opposite to a light exit surface of the apparatus from which a laser light emitted from the LD 12 exits.

An optical scanning apparatus 10A illustrated in FIG. 1B has a reflective mirror 16 instead of the polarization prism 15. Also in the optical scanning apparatus 10A, the mirror of the optical MEMS 14 is arranged at a position opposite to the light exit surface of the apparatus from which a laser light emitted from the LD 12 exits. Similar to the optical scanning apparatus 10A, the optical scanning apparatus 10B includes the optical MEMS 14 having a mirror arranged at a position opposite to the light exit surface of the apparatus from which a laser light emitted from the LD 12 exits.

Japanese Laid-Open Patent Application No. 2000-275573 discloses a laser pointer having a mirror provided at a position opposite to an exit surface of a laser light.

For example, if an optical scanning apparatus is used as a laser pointer or the like, it is desirable to miniaturize the entire apparatus. However, in the above-mentioned structure in which a mirror is arranged at a position opposite to the exit surface of a laser light, it is difficult to accommodate in, for example, a pen-like elongated structure.

### SUMMARY OF THE INVENTION

It is a general object of the present invention to provide an optical scanning apparatus and a laser pointer in which the above-mentioned problems are eliminated.

A more specific object of the present invention is to provide an optical scanning apparatus and a laser pointer which can be accommodated in a pen-like elongated structure.

There is provided according to one aspect of the present invention an optical scanning apparatus including: a light source; a lens through which a light emitted from the light source transmits; a reflective member reflecting the light transmitting the lens; and a mirror configured to scan the light reflected by the reflective member, wherein the light is projected in the same direction as an emitting direction of the light from the light source by causing the mirror to swing; the reflective member has a first reflective surface facing toward the light source and a second reflective surface facing toward a light exit surface from which the light exits from the optical scanning apparatus; the light source and the lens are arranged in a longitudinal direction of a case of the optical scanning apparatus; and the mirror and the reflective member are arranged in a transverse direction of the case.

There is provided according to another aspect of the present invention a laser pointer including: a housing having a cylindrical shape; and the above-mentioned optical scanning apparatus accommodated in the housing.

Other objects, features and advantages of the present invention will become more apparent from the following detailed description when read in conjunction with the accompanying drawings.

### BRIEF DESCRIPTION OF THE DRAWINGS

FIGS. 1A, 1B and 1C are illustrations showing outline structures of conventional optical scanning apparatuses;

FIG. 2A is a perspective vies of an optical scanning apparatus according to a first embodiment;

FIG. 2B is a perspective view of the optical scanning apparatus in a state where a case is removed;

FIG. 3 is an illustration showing an outline structure of the optical scanning apparatus according to the first embodiment;

FIG. 4 is a cross-sectional view of an optical MEMS;

FIG. 5 is a perspective view of the optical scanning apparatus in a state where a lens is removed;

FIG. 6 is a perspective view of the optical scanning apparatus in a state where an LD holder is removed;

FIGS. 7A, 7B and 7C are illustrations showing optical paths of a light incident on a light-receiving element; and

FIG. 8 is an illustration showing an outline structure of an optical scanning apparatus according to a second embodiment.

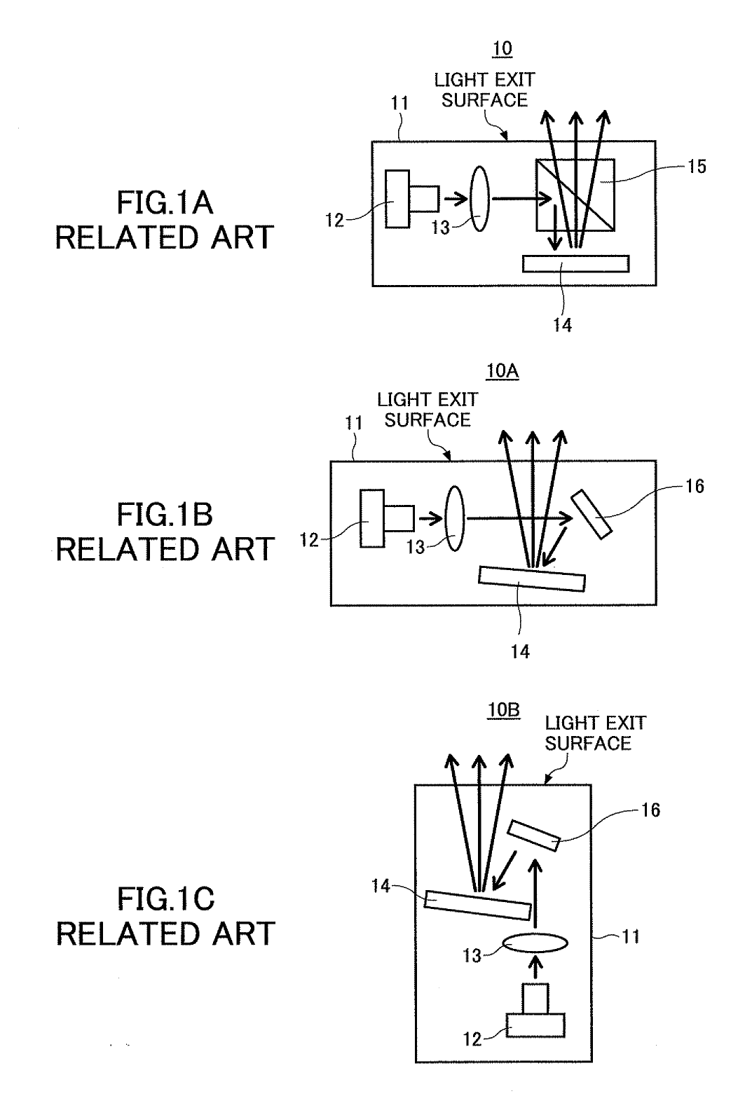

### DETAILED DESCRIPTION OF THE PREFERRED EMBODIMENTS

A description will be given below, with reference to the drawings, of embodiments according to the present invention.

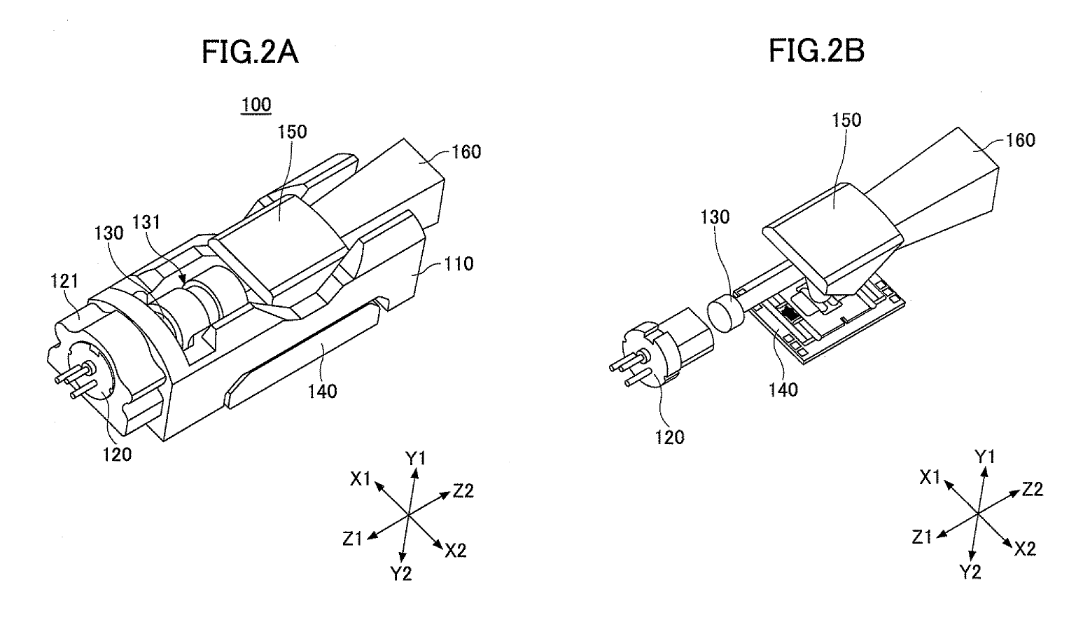

FIG. 2A is a perspective view of an optical scanning apparatus according to a first embodiment. FIG. 2B is a perspective view of the optical scanning apparatus in a state where a case is removed.

The optical scanning apparatus 100 according to the first embodiment of the present invention is used for, for example, a laser pointer which projects an image by a laser light. The optical scanning apparatus 100 includes a laser diode (hereinafter, referred to as an LD) 120, a lens 130, an optical MEMS mirror 140, and a reflective mirror 150. Component parts other than the LD 120 are accommodated in a case 110. The LD 120 is accommodated in an LD holder 121, and the LD holder 121 is fixed to the case 110. The lens 130 is accommodated in a lens holder 131, and the lens holder 131 is accommodated in the case 110.

In the optical scanning apparatus 100, the LD holder 121 and the lens holder 131 are arranged so that the LD 120 and the lens 130 are aligned in a longitudinal direction (hereinafter, referred to as Z1-Z2 direction) of the case 110. In the optical scanning apparatus 100, the optical MEMS mirror 140 and the reflective mirror 150 are arranged to be aligned in a transverse direction (hereinafter, referred to as Y1-Y2 direction) of the case.

The LD 120 is a light source to project a laser light. The laser light projected from LD 120 transmits the lens 130, and is reflected by the reflective mirror 150. The laser light reflected by the reflective mirror 150 is reflected by a mirror 141 provided in the optical MEMS mirror 140. The laser light reflected by the mirror 141 is reflected again by the reflective mirror 150 and, then, exits from a light exit surface 160.

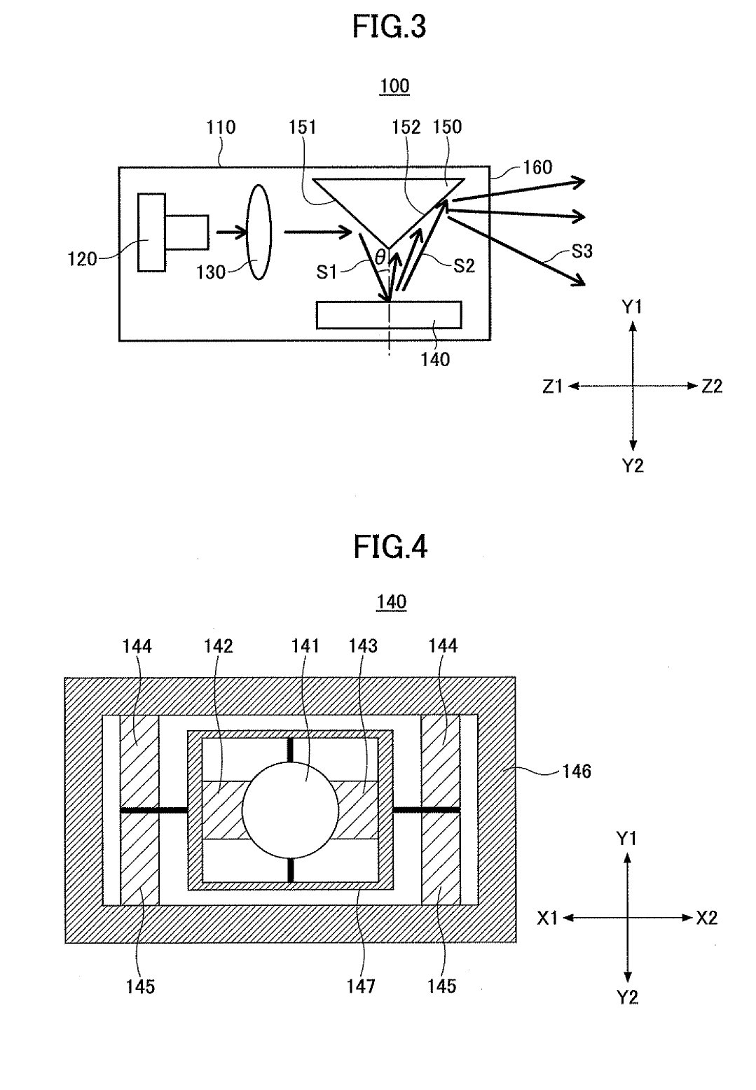

FIG. 3 is an illustration showing an outline structure of the optical scanning apparatus 100 according to the first embodiment. In the optical scanning apparatus 100, a mirror surface of the mirror 141 provided in the optical MEMS mirror 140 is arranged to be directed in a direction substantially perpendicular to the light exit surface 160 from which a laser light exits. The mirror 141 provided in the optical MEMS mirror 140 is a mirror for scanning a laser light. A structure of the optical MEMS mirror 140 will be explained later.

In the optical scanning apparatus 100 according to the present embodiment, the LD 120 and the lens 130 are arranged to be substantially parallel to the longitudinal direction of the case 110. Additionally, the optical MEMS mirror 140 and the reflective mirror 150 are arranged to be substantially parallel to the transverse direction of the case 110.

The reflective mirror 150 of the present embodiment has a triangular prism-shape, and has a reflective surface 151 and a reflective surface 152. The reflective surface 151 is formed so that the reflective surface 141 faces the LD 120 and the reflective surface 152 faces the light exit surface 160. In the present embodiment, a number of component parts is reduced by forming the reflective mirror to have the two reflective surfaces 151 and 152.

The reflective mirror 150 may be formed by two or more optical component parts. For example, the reflective mirror 150 may be constituted by one optical component part having a reflective surface facing the LD 120 and one optical component part having a reflective surface facing the light exit surface 160.

The laser light emitted from the LD 120 passes through the lens 130 and is reflected by the reflective surface 151. This reflected light is referred to as a first reflected light S1. The first reflected light S1 is incident on the optical MEMS mirror 140, and is reflected further by the optical MEMS mirror 140. This reflected light is referred to as a second reflected light S1. The second reflected light S2 is reflected further by the reflective surface 152. This reflected light is referred to as a third reflected light S3. The third reflected light S3 exits the case 110 through the light exit surface 160, and thereby a light image is projected.

In the present embodiment, the LD 120, the lens 130, the optical MEMS mirror 140, and the reflective mirror 150 are arranged respectively so that the first reflected light S1 travels toward the mirror of the optical MEMS mirror 140, the second reflected light S2 travels toward the reflective surface 152 and the third reflective light S3 exits from the light exit surface 160 in a direction substantially parallel to Z1-Z2 direction.

That is, in the optical scanning apparatus 100 according to the present embodiment, the exiting direction of the laser light exiting from the light exit surface 160 is the same direction as the emitting direction of the laser light from the LD 120. Additionally, the longitudinal direction of the case 110 and the longitudinal direction of the optical MEMS mirror 140 are the same direction.

For this reason, in the present embodiment, the length of the case 110 in Y1-Y2 direction can be shortened, and, thereby, the case 110 can be made into a cylindrical shape like a pen, for example. The length of the case 110 in Y1-Y2 direction can be a length by which the optical MEMS mirror 140 and the reflective mirror 150 can be arranged along the longitudinal direction, and, thus, the length of the case 110 in Y1-Y2 direction can be shortened.

It is desirable that the reflective mirror 150 of the present embodiment is formed with the reflective surfaces 151 and 152 so that the incident angle θ of the first reflected light S1 on the optical MEMS mirror 140 is close to zero (0) degree. A distortion of a projected image by the laser light can be made smaller as the incident angle θ is closer to zero (0) degree.

A description will be given below, with reference to FIG. 4, of the optical MEMS mirror 140 of the present embodiment. FIG. 4 is an illustration showing an outline structure of the optical MEMS.

The optical MEMS mirror 140 is configured by combining a mirror 141, a mechanism of swinging the mirror 141 to scan a light, and wiring to supply a drive power to the mirror 141 together into one piece. The optical MEMS mirror 140 can also be a structure in which a driver IC for controlling the swing of the mirror 141 is also formed together into one piece.

FIG. 3 illustrates the mirror 141 and the mechanism to swing the mirror 141 to scan a light. The optical MEMS mirror 140 has cantilevers 142 and 143 to cause the mirror 141 to swing in X1-X2 direction and cantilevers 144 and 145 to cause the mirror 141 to swing in Y1-Y2 direction. The cantilevers 144 and 145 cause the mirror 141 to swing in Y1-Y2 direction together with the cantilevers 142 and 143 and an inner frame 147.

The cantilevers 142 and 143 are arranged on both sides of the mirror 141 with the mirror 141 interposed therebetween, and are supported by the inner frame 147. The inner frame 147 is supported by an outer frame 146 via the cantilevers 144 and 145.

The cantilevers 142 and 143 are provided with piezoelectric elements (not shown), respectively. When a voltage is applied, each of the piezoelectric elements generates a displacement. Due to the displacements of the cantilevers 142 and 143, the mirror 141 is caused to swing in X1-X2 direction. A mirror drive voltage is applied to the piezoelectric elements of the cantilevers 142 and 143 by the drive IC to drive the mirror 141.

Similar to the cantilevers 142 and 143, the cantilevers 144 and 145 are provided with piezoelectric elements, respectively. When a voltage is applied, each of the piezoelectric elements generates a displacement. Due to the displacements of the cantilevers 142 and 143, the mirror 141 is caused to swing in Y1-Y2 direction together with the cantilevers 142 and 143. A mirror drive voltage is applied to the cantilevers 144 and 145 by the drive IC.

Although the optical MEMS mirror 140 of the present embodiment has a two-axis structure to swing the mirror 141 in two directions, X1-X2 direction and Y1-Y2 direction, as mentioned above, a one-axis structure may be used. Additionally, the optical MEMS mirror 140 may have structures other than the above-mentioned structure.

In the optical scanning apparatus 100 according to the present embodiment, the first reflected light S1 incident on the optical MEMS mirror 140 is determined by the LD 120 and the lens 130. A condensing condition of the first reflected light S1 is changed by a distance (Z1-Z2 direction) between the LD 120 and the lens 130. Moreover, an inclination of the optical axis of the first reflected light S1 is changed by distances (X1-X2 direction, Y1-Y2 direction) between the axis of the lens 130 and the light emitting point of the LD 120.

Therefore, the optical scanning apparatus 100 is provided with a mechanism to adjust a relative position between the LD 120 and the lens 130. According to such an adjusting mechanism the optical scanning apparatus 100 can adjust easily the positional relationship between the LD 120 and the lens 130 in X1-X2 direction, Y1-Y2 direction, and Z1-Z2 direction.

FIG. 5 is a view for explaining the adjusting mechanism, and is a perspective view of the optical scanning apparatus 100 in a state where the lens 130 is removed. In the present embodiment, the lens holder 131 is arranged in a groove part 132 formed in the case 110 so that the lens holder 131 is movable along the groove part 132. The groove part 132 serves as a guide member to guide the lens holder 131 in the exiting direction of the light (Z1-Z1 direction), and has, for example, a V-shaped cross section. According to this structure, the lens 130 can be moved in Z1-Z2 direction, thereby easily adjusting the distance between the LD 120 and the lens 130. The lens 130 and the lens holder 131 may be formed integrally by a resin or the like.

In the example shown in FIG. 5, a concave part 122 is formed in each of an X1-side surface and an X2-side surface of the LD holder 121. In the present embodiment, the LD holder 121 is grasped by an assembling equipment using the concave parts 122, and the LD holder 121 can be moved in X1-X2 direction and Y1-Y2 direction to adjust an angle of a light beam transmitted through the lens 130. After the position of the LD holder 121 is adjusted, the LD holder 121 may be bonded to the case using contact surfaces.

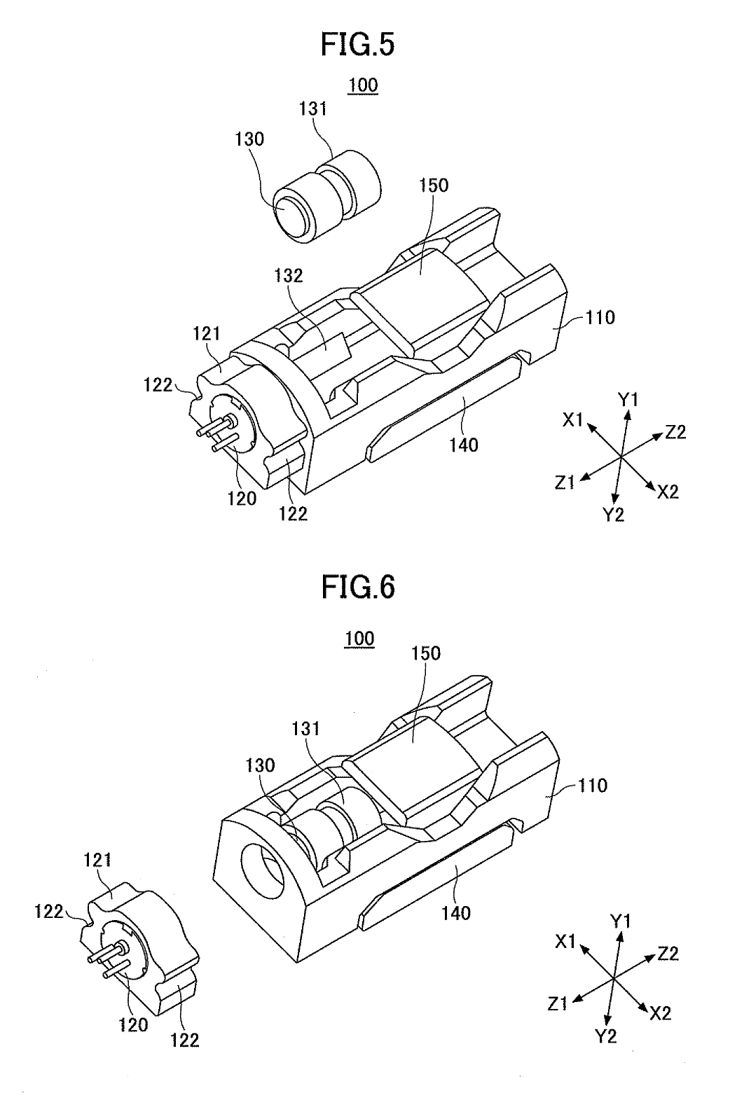

A description is given, with reference to FIG. 6, of another example of the adjusting mechanism of the present embodiment. FIG. 6 is a view for explaining the adjusting mechanism, and is a perspective view of the optical scanning apparatus 100 in a state where the LD holder 121 is removed.

In the example shown in FIG. 6, an adjustment is performed by moving the LD holder 121 in X1-X2 direction, Y1-Y2 direction, and Z1-Z2 direction in a state where the lens holder 131 is fixed to the case 110. In the example shown in FIG. 6, a distance between the LD 120 and the lens 130 is adjusted by moving the LD holder 121 in Z1-Z2 direction, and, thereby, a condensing condition of the light incident on the optical MEMS mirror 140 can be adjusted.

After the distance between the LD holder 121 and the lens 130 is determined, the LD holder 121 is moved in X1-X2 direction and Y1-Y2 direction, and, thereby, the incident angle of the first reflected light S1 can be adjusted. After the adjustment is completed, an adhesive or a solder is supplied between the LD holder 121 and the case 110 to fix the LD holder 121 to the case 110.

In the present embodiment, a mechanism to rotate the LD 120 about axes (X-axis and Y-axis) perpendicular to Z1-Z2 direction in each of the example illustrated in FIG. 5 and FIG. 6. In the present embodiment, an intensity distribution of the light beam of the first reflected light S1 can be adjusted.

Moreover, in the optical scanning apparatus 100 of the present embodiment, one of the reflective surfaces 151 and 152 of the reflective mirror 150 is made into a half mirror, and a light-receiving element for a light-amount monitor is provided to receive a light transmitted through the half mirror. Here, the half mirror is a mirror which reflects or transmits a fixed amount of light. For example, the half mirror is set to but not limited to 90%-reflection and 10%-transmission.

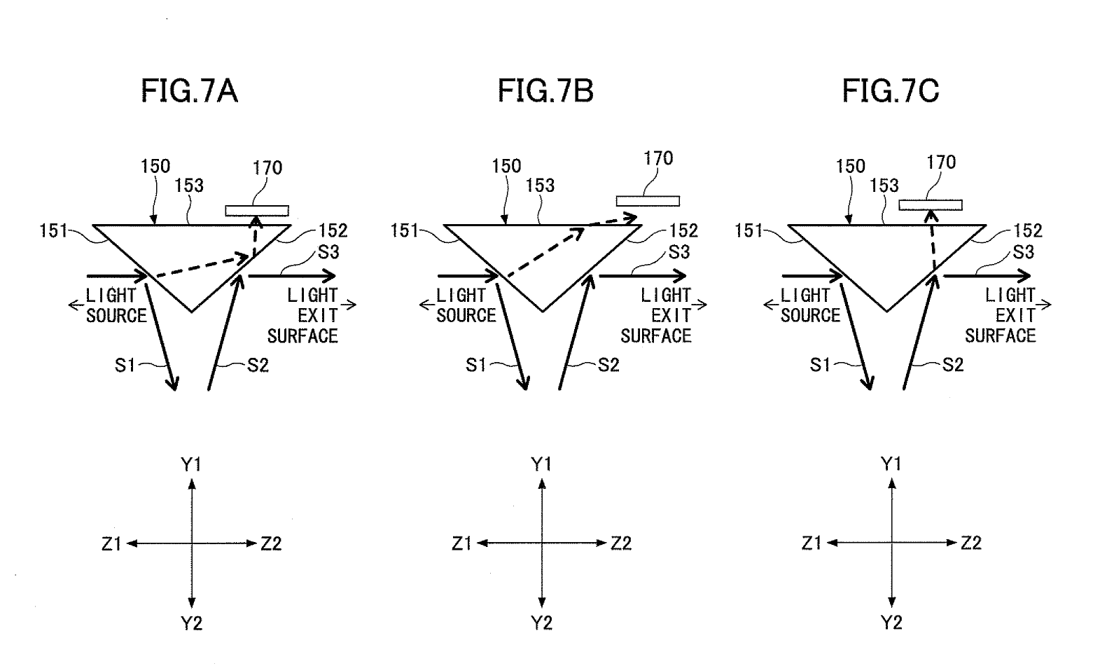

FIGS. 7A-7C are illustrations for explaining the light-receiving element for light amount monitor. Because efficiency of optical output with respect to a drive current of the LD 120 fluctuates due to influences of a temperature, etc., it is necessary to perform a drive control on the LD 120.

The drive control is performed based on an amount of light obtained by monitoring an amount of light that is actually output. In the present embodiment, the reflective surface on a side opposite to a side where the light-receiving element is provided is made into a half mirror to branch the first reflected light S1. Then, an amount of the light is monitored on an optical path different from an optical path of the third reflected light S3, which is an output of the optical scanning apparatus 100.

FIG. 7A illustrates a first example in which the reflective surface 151 is made into a half mirror. FIG. 7B illustrates a second example in which the reflective surface 151 is made into a half mirror. FIG. 7C illustrates a third example in which the reflective surface 152 is made into a half mirror.

In the first example illustrated in FIG. 7A, the laser light from the LD 120 transmits through the reflective surface 151, which is a half mirror, and is reflected by the reflective surface 152 and is projected toward a light-receiving element 170. The light-receiving element 170 is arranged at a position which does not overlap the reflective surface 151, at a position closer to the light exit surface 160 than the reflective surface 151.

In the second example illustrated in FIG. B, the laser light from the LD 120 transmits the reflective surface 151, which is a half mirror, and exits from an upper surface 153 of the reflective mirror 150 toward the light-receiving element 170. Also in the second example illustrated in FIG. 7B, the light-receiving element 170 is arranged on the backside of the reflective surface 151. The position of the light-receiving element 170 in the second example illustrated in FIG. 7B is closer to the light exit surface 160 than the first example illustrated in FIG. 7A.

In the third example illustrated in FIG. 7C, the laser light from the LD 120 transmits through the reflective surface 152, which is a half mirror, and exits from the upper surface 153 of the reflective mirror 150 toward the light-receiving element 170. The light-receiving element 170 is arranged at a position overlapping the reflective surface 152 in Y1-Y2 direction.

In the present embodiment, an amount of light of the laser light emitted from the LD 120 can be monitored by providing the light-receiving element 170 for light amount monitor. Which arrangement of FIG. 7A, FIG. 7B or FIG. 7C is optimum can be determined by an incident angle of the light relative to the half mirror of the reflection mirror 150 and a refractive index of the half mirror of the reflection mirror 150. In the present embodiment, although it is desirable to arrange the light-receiving element 170 at a position at which the light-receiving element 170 does not overlap the reflective surface 151 and closer to the light exit surface 160 than the reflective surface 151, the light-receiving element 170 may be arranged at a positioned at which the light-receiving element overlaps the reflective surface 151.

As explained above, the optical scanning apparatus 100 according to the present embodiment can be miniaturized as compared to a conventional apparatus. Particularly, the optical scanning apparatus 100 according to the present embodiment can be made into an elongated cylindrical shape, and can be used as a pen-shaped laser pointer.

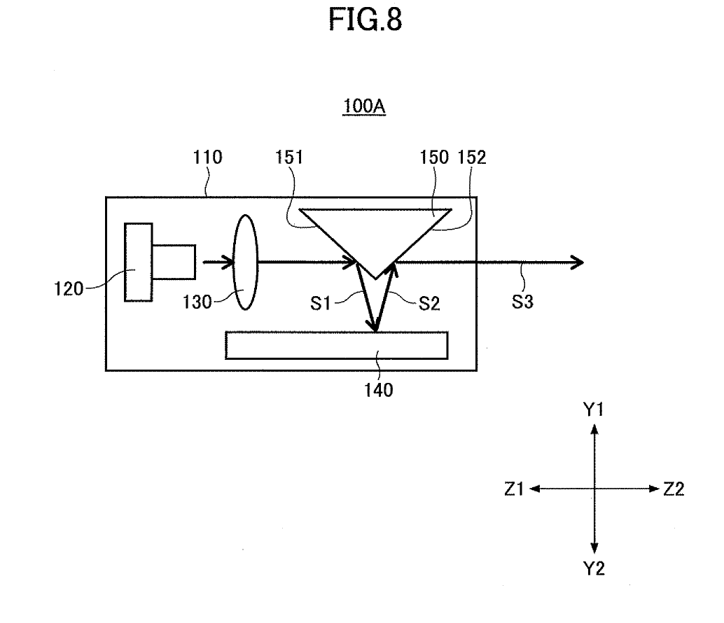

A description is given below, with reference to FIG. 8, of a second embodiment of the present invention.

The second embodiment of the present invention differs from the first embodiment only in that the lens 130 and the optical MEMS mirror 140 overlaps with each other in Y1-Y2 direction. In the description of the second embodiment, the difference between the first embodiment and the second embodiment will be explained, and parts that have the same functional structures as the first embodiment are given the same reference numerals, and descriptions will be omitted.

FIG. 8 is an illustration indicating an outline structure of an optical scanning apparatus 100A according to the second embodiment. In the optical scanning apparatus 100A according to the second embodiment, a distance between the optical MEMS mirror 140 and the lens 130 is reduced so that the optical MEMS mirror 140 and the lens 130 overlap with each other in Y1-Y2 direction.

In the present embodiment, according to the above-mentioned structure, a length of the case 110 in Z1-Z2 direction is shortened further, which contributes to a further miniaturization of the entire apparatus.

The present invention is not limited to the specifically disclosed embodiments, and variations and modifications may be made without departing from the scope of the present invention.

The present application is based on Japanese priority application No. 2010-225192 filed on Oct. 4, 2010, the entire contents of which are hereby incorporated herein by reference.

What is claimed is:

1. An optical scanning apparatus comprising:
a light source;
a lens through which a light emitted from said light source transmits;
a reflective member reflecting the light transmitting said lens; and
a mirror configured to scan the light reflected by said reflective member,
wherein said light is projected in the same direction as an emitting direction of the light from said light source by causing said mirror to swing;
said reflective member has a first reflective surface facing toward said light source and a second reflective surface facing toward a light exit surface from which said light exits from said optical scanning apparatus;
said light source and said lens are arranged in a longitudinal direction of a case of said optical scanning apparatus; and
said mirror and said reflective member are arranged in a transverse direction of said case.

2. The optical scanning apparatus as claimed in claim 1, further comprising a structure in which said mirror and a mechanism to cause said mirror to swing are integrally formed into one piece, and said structure and said lens are arranged to overlap each other in the transverse direction of said case.

3. The optical scanning apparatus as claimed in claim 1, wherein said first reflective surface and said second reflective surface is made into a half mirror, and a light-receiving element is provided to receive the light emitted from said light source and transmitted through said half mirror.

4. The optical scanning apparatus as claimed in claim 1, further comprising an adjusting mechanism to adjust a positional relationship between said light source and said lens, wherein said adjusting mechanism includes a guide member formed in the same direction as the longitudinal direction of said case so that a lens holder accommodating said lens slide in the same direction as an emitting direction of said light from said light source.

5. The optical scanning apparatus as claimed in claim 4, wherein said guide member is a groove part having a V-shaped cross section.

6. The optical scanning apparatus as claimed in claim 1, further comprising an adjusting mechanism to adjust a positional relationship between said light source and said lens, wherein said adjusting mechanism includes a holder support part configured to adjust a position of a light source holder accommodating said light source in a direction substantially perpendicular to an emitting direction of said light from said light source.

7. The optical scanning apparatus as claimed in claim 6, wherein said holder support part adjusts a position of said light source holder in the same direction as an emitting direction of said light from said light source.

8. The optical scanning apparatus as claimed in claim 6, wherein said holder support part includes concave parts formed on both ends of said light source holder in the transverse direction of said case.

9. A laser pointer comprising:
a housing having a cylindrical shape; and
the optical scanning apparatus as claimed in claim 1 accommodated in said housing.
